(19) United States
(12) Patent Application Publication
(10) Pub. No.: US 2020/0396325 A1
(43) Pub. Date: Dec. 17, 2020

(54) APPLICATION SWITCHING METHOD AND TERMINAL

(71) Applicant: HUAWEI TECHNOLOGIES CO., LTD., Shenzhen, Guangdong (CN)

(72) Inventors: Jinhong ZHONG, Shanghai (CN); Hua JIN, Shanghai (CN)

(21) Appl. No.: 16/968,375

(22) PCT Filed: Feb. 8, 2018
(86) PCT No.: PCT/CN2018/075876

§ 371 Date: Aug. 7, 2020

(51) Int. Cl. H04M 1/673; H04M 1/725; H04L 29/08; G06F 21/32; G06F 9/54

(52) U.S. Cl. CPC H04M 1/673; H04M 1/72558; H04M 1/72572; G06F 3/04883; H04L 67/18; G06F 21/32; G06F 9/542; H04L 67/24

(57) ABSTRACT

The technology described in this application relates to an application switching method and a terminal. The method includes a terminal running a first application in the foreground, locking a screen of the terminal in response to a lock screen instruction, and when the terminal meets a preset condition of running a second application, unlocking the screen of the terminal in response to an unlock instruction, and running the second application in the foreground.

### CROSS REFERENCE TO RELATED APPLICATION(S)

This application is a national stage of International Application No. PCT/CN2018/075876, filed on Feb. 08, 2018, which is hereby incorporated by reference in its entirety.

### TECHNICAL FIELD

Embodiments of this application relate to the field of communications technologies, and in particular, to an application switching method and a terminal.

### BACKGROUND

To ensure security of important information such as user privacy, terminals such as a mobile phone and a tablet computer generally have a function. After a screen of a terminal is locked, a user needs to input correct identity authentication information (for example, a digital codeword, a gesture codeword, or a fingerprint) to the terminal, to trigger the terminal to unlock the screen, so that interactivity between the screen of the terminal and the user is resumed.

Currently, after unlocking the screen, the terminal always displays, to the user, a display interface that is of the terminal before the screen is locked most recently. For example, as shown in FIG. 1, when the user browses a picture by using the album on the terminal, if detecting that the user inputs a lock screen operation to the terminal, the terminal enters a lock screen state. Subsequently, when receiving correct identity authentication information input by the user to the terminal, the terminal unlocks the screen and continues to display a picture that is browsed before the screen is locked.

Then, when the terminal in the lock screen state receives a new message such as a short message service message or a WeChat message, or the user wants to use, when unlocking the terminal, a function provided by another application, the terminal needs to first exit a current display interface after the screen is unlocked, to search for and open a target application desired by the user. As a result, an application switching process before and after the screen is unlocked is relatively tedious, reducing efficiency of interaction between the terminal and the user.

### SUMMARY

Embodiments of this application provide an application switching method and a terminal, to simplify an application switching process before and after a screen is unlocked, and improve efficiency of interaction between the terminal and a user.

To achieve the foregoing objective, the following technical solutions are used in the embodiments of this application.

According to a first aspect, an embodiment of this application provides an application switching method, including: running, by a terminal, a first application in the foreground; locking, by the terminal, a screen of the terminal in response to a lock screen instruction; and when the terminal meets a preset condition of running a second application, unlocking, by the terminal, the screen of the terminal in response to an unlock instruction, and running the second application (the first application is different from the second application) in the foreground. In other words, when the terminal detects, when the screen is locked, that the terminal meets a preset condition of running an application (namely, the second application), it indicates that a user wants to open the application when the screen of the terminal is unlocked. Then, when receiving the unlock instruction input by the user, the terminal can intelligently, conveniently, and automatically switch, for the user, an application that is run in the foreground from the first application that is run before the screen is locked to the second application needed by the user, to improve efficiency of interaction between the terminal and the user.

For example, the preset condition includes at least one of the following: the terminal in a lock screen state receives a new message related to the second application, the terminal in a lock screen state detects that the terminal is connected to an audio output device, the terminal in a lock screen state detects that a current location is within a preset geo-fencing, or the terminal in a lock screen state detects that a current time is within a preset time period.

When the preset condition is that the terminal in the lock screen state receives the new message related to the second application, the running, by the terminal, the second application in the foreground includes: running, by the terminal, a detail interface of the new message in the second application in the foreground; or running, by the terminal, a preview interface of the new message in the second application in the foreground, so that the user quickly reads the unread new message.

The new message includes at least one of a short message service message, a missed call notification, an instant messaging message, an application update prompt, a push message, and an advertisement message.

In a possible implementation, after the terminal in the lock screen state receives the new message related to the second application, the method further includes: opening, by the terminal, the second application in the background. In this way, after receiving the unlock instruction, the terminal may automatically switch the second application that is run in the background to be run in the foreground, to reduce a time of waiting for starting of the second application by the user.

In a possible implementation, the new message is received by the terminal at a first moment, and then the running, by the terminal, the second application in the foreground includes: running, by the terminal, a first interface of the second application in the foreground if the terminal obtains the unlock instruction at a moment between the first moment and a second moment, where the second moment is later than the first moment; and running, by the terminal, a second interface of the second application in the foreground if the terminal obtains the unlock instruction at a moment between the second moment and a third moment, where the third moment is later than the second moment.

In addition, if the terminal obtains the unlock instruction after the third moment, the method further includes: continuing, by the terminal, to run the first application in the foreground.

In other words, the terminal may further set effective duration of switching to the second application by the terminal, so that the terminal may determine, based on the effective duration, whether to switch from the first application that is run before the screen is locked to the second application to which the new message belongs, and when determining to switch to the second application, the terminal may further determine, based on the effective duration, a specific interface that is of the second application and to which the terminal switches.

In a possible implementation, the running, by a terminal, a first application in the foreground includes: running, by the terminal, a first interface of the first application in the foreground; and in this case, the running, by the terminal, the second application in the foreground includes: when a priority of a target interface to which the new message belongs is higher than a priority of the first interface, running, by the terminal, the target interface of the second application in the foreground.

When the preset condition is that the terminal in a lock screen state detects that the terminal is connected to an audio output device of the terminal, it indicates that the user has an operation intention of playing back audio when the screen is unlocked subsequently. Therefore, the second application may be an application supporting audio playback. In this case, the running, by the terminal, the second application in the foreground includes: if the terminal in a state of being connected to the audio output device receives the unlock instruction for the first time, running, by the terminal, the second application in the foreground. In this way, the terminal only needs to switch the second application to be run in the foreground when the terminal receives the unlock instruction for the first time after being connected to the audio output device, and when the terminal device in the state of being connected to the audio output device receives the unlock instruction again (not for the first time), the terminal may not switch the second application, to avoid a case of causing inconvenience to the user when the terminal frequently jumps to the second application when the screen is unlocked.

Alternatively, the preset condition includes any one or two of the following: the terminal in a lock screen state detects that a current location is within a preset geo-fencing, or the terminal in a lock screen state detects that a current time is within a preset time period.

When the preset geo-fencing is near a preset clock-in/out location, and the preset time period is a preset clock-in/out time period, it indicates that the user has an operation intention of recording attendance when the screen is unlocked subsequently. Therefore, the second application may be an attendance tracking application. In this case, the running, by the terminal, the second application in the foreground includes: when the terminal receives the unlock instruction within the clock-in/out time period for the first time, running, by the terminal, the second application in the foreground.

Further, after the running, by the terminal, the second application in the foreground, the method further includes: if detecting that the user performs a clock-in/out operation in the second application, continuing, by the terminal, to run the first application in the foreground when the terminal receives, again, an unlock operation input by the user, to avoid a case of disturbing the user because the terminal frequently displays a clock-in/out application when the user unlocks the terminal during the clock-in hours or clock-out hours; and if detecting that the user does not perform a clock-in/out operation in the second application, running, by the terminal, the second application in the foreground when the terminal receives, again, the unlock operation input by the user, to prevent the user from forgetting to clock in/out.

When the preset geo-fencing is a historical location at which the user uses the second application, and the preset time period is a historical time at which the user uses the second application, it indicates that the user has an operation intention of using the second application when the screen is unlocked subsequently. In this case, the second application may be a game or reading application.

When the preset geo-fencing is a station, it indicates that the user intends to use an e-ticket when the screen is unlocked subsequently. Therefore, the second application may be an application including an e-ticket.

Further, in any one of the foregoing implementations, the preset condition may further include: a priority of the second application is higher than a priority of the first application.

In a possible implementation, the running, by the terminal, the second application in the foreground includes: switching, by the terminal, the second application from the background to be run in the foreground; or opening, by the terminal, the second application, and running the second application in the foreground.

According to a second aspect, an embodiment of this application provides a terminal, including: a running unit, configured to run a first application in the foreground; a lock screen unit, configured to lock a screen of the terminal in response to a lock screen instruction; and an unlock unit, configured to: when the terminal meets a preset condition of running a second application, unlock the screen of the terminal in response to an unlock instruction, where the running unit is further configured to run the second application in the foreground, where the first application is different from the second application.

In a possible implementation, the preset condition includes: the terminal in a lock screen state receives a new message related to the second application, where the new message includes at least one of a short message service message, a missed call notification, an instant messaging message, an application update prompt, a push message, and an advertisement message; and the running unit is configured to: run a detail interface of the new message in the second application in the foreground, or run a preview interface of the new message in the second application in the foreground.

In a possible implementation, the new message is received by the terminal at a first moment, and the running unit is configured to: run a first interface of the second application in the foreground if the terminal obtains the unlock instruction at a moment between the first moment and a second moment, where the second moment is later than the first moment; and run a second interface of the second application in the foreground if the terminal obtains the unlock instruction at a moment between the second moment and a third moment, where the third moment is later than the second moment.

In a possible implementation, the running unit is further configured to continue to run the first application in the foreground if the terminal obtains the unlock instruction after the third moment.

In a possible implementation, the running unit is configured to: run a first interface of the first application in the foreground; and when a priority of a target interface to which the new message belongs is higher than a priority of the first interface, run the target interface of the second application in the foreground.

In a possible implementation, the preset condition includes: the terminal in a lock screen state detects that the terminal is connected to an audio output device; the second application is an application supporting audio playback; and the running unit is configured to run the second application in the foreground if the terminal in a state of being connected to the audio output device receives the unlock instruction for the first time.

In a possible implementation, the preset condition includes any one or two of the following: the terminal in a lock screen state detects that a current location is within a preset geo-fencing, or the terminal in a lock screen state detects that a current time is within a preset time period; when the second application is an attendance tracking application, the preset geo-fencing is near a preset clock-in/out location, and the preset time period is a preset clock-in/out time period; when the second application is a game or reading application, the preset geo-fencing is a historical location at which the user uses the second application, and the preset time period is a historical time at which the user uses the second application; or when the second application is an application including an e-ticket, the preset geo-fencing is a station.

In a possible implementation, the preset condition further includes: a priority of the second application is higher than a priority of the first application.

According to a third aspect, an embodiment of this application provides a terminal, including a processor, a memory, and a communications interface. The memory is configured to store a computer executable instruction, the processor is coupled to the memory, and when the terminal is run, the processor executes the computer executable instruction stored in the memory, so that the terminal performs any application switching method described above.

According to a fourth aspect, an embodiment of this application provides a computer readable storage medium. The computer readable storage medium stores an instruction, and when the instruction is run on any terminal described above, the terminal is enabled to perform any application switching method described above.

According to a fifth aspect, an embodiment of this application provides a computer program product including an instruction. When the instruction is run on any terminal described above, the terminal is enabled to perform any application switching method described above.

In the embodiments of this application, names of components of the terminal do not constitute a limitation to the device itself, and during actual implementation, the components may have other names. The names belong to the scope of the claims of this application and equivalent technologies thereof provided that functions of the components are similar to those in the embodiments of this application.

In addition, for a technical effect of any implementation of the second aspect to the fifth aspect, refer to technical effects of different implementations of the first aspect.

### BRIEF DESCRIPTION OF DRAWINGS

FIG. 1 is a schematic diagram of a scenario when a terminal is unlocked in the related art;

FIG. 2 is a first schematic structural diagram of a terminal according to an embodiment of this application;

FIG. 3 is a schematic architectural diagram of a programming module of a terminal according to an embodiment of this application;

FIG. 4 is a schematic diagram of a principle when a terminal is unlocked in the related art;

FIG. 5 is a first schematic diagram of a scenario of an application switching method according to an embodiment of this application;

FIG. 6 is a second schematic diagram of a scenario of an application switching method according to an embodiment of this application;

FIG. 7 is a third schematic diagram of a scenario of an application switching method according to an embodiment of this application;

FIG. 8A, FIG. 8B and FIG. 8C are fourth schematic diagrams of a scenario of an application switching method according to an embodiment of this application;

FIG. 9A, FIG. 9B and FIG. 9C are fifth schematic diagrams of a scenario of an application switching method according to an embodiment of this application;

FIG. 10A and FIG. 10B are sixth schematic diagrams of a scenario of an application switching method according to an embodiment of this application;

FIG. 11A, FIG. 11B, FIG. 11C and FIG. 11D are seventh schematic diagrams of a scenario of an application switching method according to an embodiment of this application;

FIG. 12A and FIG. 12B are eighth schematic diagrams of a scenario of an application switching method according to an embodiment of this application;

FIG. 13 is a ninth schematic diagram of a scenario of an application switching method according to an embodiment of this application;

FIG. 14 is a tenth schematic diagram of a scenario of an application switching method according to an embodiment of this application;

FIG. 15 is an eleventh schematic diagram of a scenario of an application switching method according to an embodiment of this application;

FIG. 16(a) and FIG. 16(b) are a twelfth schematic diagram of a scenario of an application switching method according to an embodiment of this application;

FIG. 17 is a second schematic structural diagram of a terminal according to an embodiment of this application;

FIG. 18 is a third schematic structural diagram of a terminal according to an embodiment of this application; and

FIG. 19 is a flowchart of an application switching method according to an embodiment of this application.

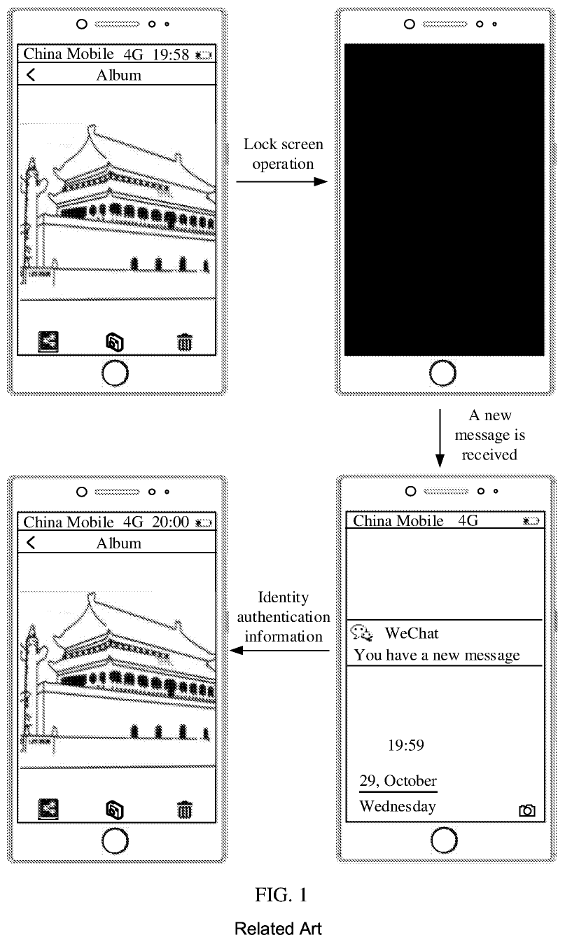

### DESCRIPTION OF EMBODIMENTS

The following terms “first” and “second” are merely intended for a purpose of description, and shall not be understood as an indication or implication of relative importance or implicit indication of the number of indicated technical features. Therefore, a feature limited by “first” or “second” may explicitly or implicitly include one or more features. In the description of the embodiment of this application, unless otherwise stated, “a plurality of” means two or more than two.

An application switching method provided in the embodiments of this application may be applied to any terminal having a file sharing function, for example, a mobile phone, a tablet computer, a wearable device, a vehicle-mounted device, an augmented reality (AR)/virtual reality (VR) device, a notebook computer, an ultra-mobile personal computer (UMPC), a netbook, or a personal digital assistant (PDA), and this is not limited in the embodiments of this application.

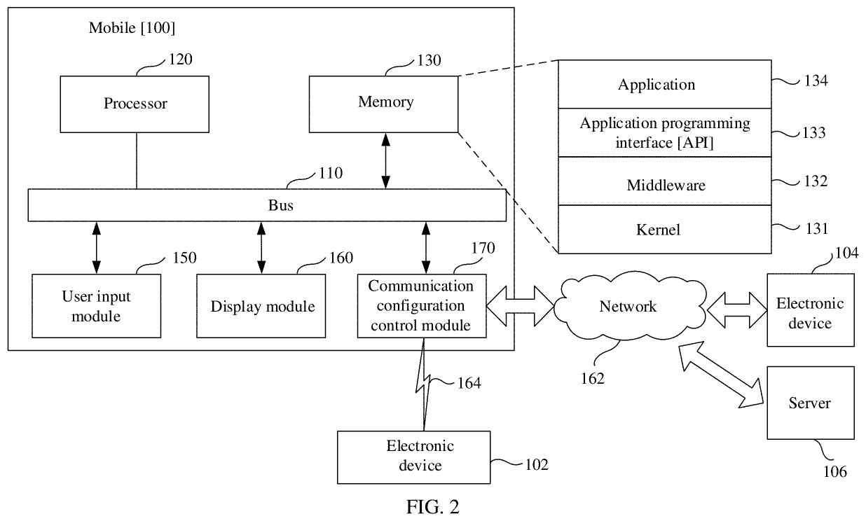

As shown in FIG. 2, the terminal in the embodiments of this application may be a mobile phone 100. The following describes the embodiments by using the mobile phone 100 as an example. It should be understood that the mobile phone 100 shown in the figure is merely an example of the terminal, and the mobile phone 100 may include more or fewer components than those shown in FIG. 2, or may combine two or more components, or may have a different component configuration.

Referring to FIG. 2, the mobile phone 100 may communicate with other electronic devices 102 and 104 than the mobile phone 100, and a server 106. The mobile phone 100 may include a bus 110, a processor 120, a memory 130, a user input module 150, a display module 160, a communications interface 170, and another similar and/or appropriate component.

The bus 110 may be a circuit connecting the elements and transferring communication (for example, a control message) between the elements.

The processor 120 may receive commands from the other of the foregoing elements (for example, the memory 130, the user input module 150, the display module 160, the communications interface 170, and the communication configuration control module 170) by using the bus 110, may interpret the received command, and may perform calculation or data processing based on the interpreted command.

The memory 130 may store the commands or data received from the processor 120 or the other elements (for example, the user input module 150, the display module 160, or the communications interface 170), or commands or data generated by the processor 120 or the other elements.

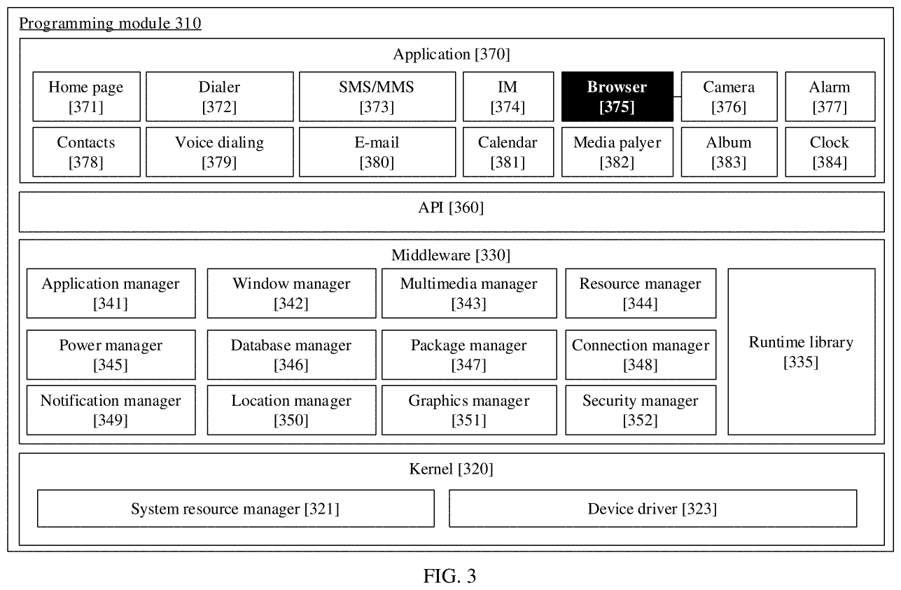

The memory 130 may include programming modules, for example, a kernel 131, middleware 132, an application programming interface (API) 133, and an application 134. Each of the programming modules may be implemented by using software, firmware, hardware, or a combination of two or more of the foregoing, and for details, refer to related descriptions in FIG. 3.

The kernel 131 may control or manage a system resource (for example, the bus 110, the processor 120, and the memory 130) used to execute an operation or a function implemented by another programming module (for example, the middleware 132, the API 133, and the application 134). In addition, the kernel 131 may provide an interface that can access and control or manage elements of the mobile phone 100 by using the middleware 132, the API 133, or the application 134.

The middleware 132 may be configured to run between the API 133 or the application 134 and the kernel 131 in a manner in which the API 133 or the application 134 and the kernel 131 communicate with each other and exchange data with the middleware 132. For example, the middleware 132 may be configured and used as a medium of communication between the API 133 or the application 134 and the kernel 131. In addition, for example, for working requests received from one or more applications 134 and/or middleware 132, load balancing between the working requests can be implemented by using a method of assigning a priority (the system resource (for example, the bus 110, the processor 120, and the memory 130) of the mobile phone 100 may be used based on the priority) to at least one of the one or more applications 134.

The API 133 is an interface through which the application 134 can control a function provided by the kernel 131 or the middleware 132, and may include, for example, at least one interface or function used for file control, window control, image processing, character control, or the like.

The application 134 may include, for example, a home page application, a dialer application, a short message service (SMS)/multimedia message service (MMS) application, an instant messaging (IM) application, a browser application, a camera application, an alarm application, a contacts application, a voice dialing application, an e-mail application, a calendar application, a media player application, an album application, a clock application, and any other appropriate and/or similar application.

The user input module 150 may receive a command or data that is input by a user by using an input-output means (for example, a sensor, a keyboard, or a touchscreen), and may transfer the received command or data to the processor 120 or the memory 130 by using the bus 110. The display module 160 may display a video, an image, data, or the like to the user.

The display module 160 may display various information (for example, multimedia data or text data) received from the foregoing elements.

The communications interface 170 may control short range communication connection with another electronic device 102. When the mobile phone 100 is paired with another electronic device, the communications interface 170 may stop a scanning operation of waiting to receive a signal from a nearby electronic device or stop a broadcast operation of broadcasting a signal. For example, when the mobile phone 100 is paired with another electronic device 102, the communications interface 170 stops a scanning operation of waiting to receive a signal from a nearby electronic device or stops a broadcast operation of broadcasting a signal. When the mobile phone 100 is paired with another electronic device, the communications interface 170 may control a period of the scanning or broadcast operation.

According to the embodiments disclosed in this application, the mobile phone 100 may communicate with another electronic device by using the communications interface 170. For example, the communications interface 170 may communicate with another electronic device 104, the server 106, or the like. The communications interface 170 may directly communicate with another electronic device 104, the server 106, or the like, or communicate with another electronic device 104, the server 106, or the like by using a network 162. For example, the communications interface 170 may be operated to connect the mobile phone 100 to the network 162.

FIG. 3 shows a block diagram of a configuration of a programming module according to an embodiment of this application.

Referring to FIG. 3, a programming module 310 may be included (or stored) in the mobile phone 100 (for example, the memory 130) shown in FIG. 2. At least a part of the programming module 310 may be implemented as software, firmware, hardware, or a combination of two or more of the foregoing. The programming module 310 may be implemented as hardware (for example, hardware 201), and may include an OS controlling a resource related to an electronic device (for example, the mobile phone 100) and/or various applications (for example, an application 370) executed in the OS. For example, the OS may be Android, iOS, Windows, Symbian, Tizen, Bada, or the like.

Referring to FIG. 3, the programming module 310 may include a kernel 320, middleware 330, an API 360, and/or the application 370.

The kernel 320 (for example, the kernel 131) may include a system resource manager 321 and/or a device driver 323. The system resource manager 321 may include a process manager (not shown), a memory manager (not shown), and a file system manager (not shown). The system resource manager 321 may perform controlling, allocation, resumption, and the like on a system resource. The device driver 323 may include, for example, a display driver (not shown), a camera driver (not shown), a Bluetooth driver (not shown), a shared memory driver (not shown), a USB driver (not shown), a keypad driver (not shown), a Wi-Fi driver (not shown), and/or an audio driver (not shown). In addition, according to this embodiment disclosed in this application, the device driver 323 may include an interprocess communication (IPC) driver (not shown).

The middleware 330 may include a plurality of pre-implemented modules, to provide functions shared by the application 370. In addition, the middleware 330 may provide a function for the application 370 by using the API 360, so that the application 370 can efficiently use a limited system resource of the electronic device. For example, as shown in FIG. 3, the middleware 330 (for example, the middleware 132) may include at least one of the following: a runtime library 335, an application manager 341, a window manager 342, a multimedia manager 343, a resource manager 344, a power manager 345, a database manager 346, a package manager 347, a connection manager 348, a notification manager 349, a location manager 350, a graphics manager 351, a security manager 352, and any other appropriate and/or similar manager.

The runtime library 335 may include, for example, a library module used by a compiler, to add a new function by using a programming language when the application 370 is executed. According to this embodiment disclosed in this application, the runtime library 335 may execute a function related to input and output, memory management, an arithmetic function, and the like.

The application manager 341 may manage, for example, a lifecycle of at least one application 370. The window manager 342 may manage a graphical user interface (GUI) resource used on a screen. The multimedia manager 343 may detect formats used to reproduce various media files, and encode or decode a media file by using a codec suitable for a related format. The resource manager 344 may manage a resource of the at least one application 370, for example, source code, a memory, and storage space.

The power manager 345 may be operated together with a basic input/output system (BIOS), may manage a battery or a power supply, and may provide power information and the like used for operation. The database manager 346 may manage a database by using the following manner: generate, search for, and/or change a database used by the at least one application 370. The package manager 347 may manage installation and/or update of an application delivered in a form of a package.

The connection manager 348 may manage wireless connection such as Wi-Fi and BT. The notification manager 349 may display or report an event such as an arrival message, dating, or an approach alarm to a user in a manner of not disturbing the user. The location manager 350 may manage location information of the electronic device. The graphics manager 351 may manage a graphics effect and/or a UI related to a graphics effect that are/is to be provided for the user. The security manager 352 may provide various security functions used for system security, user authentication, and the like. According to this embodiment disclosed in this application, when the electronic device (for example, the mobile phone 100) has a phone function, the middleware 330 may further include a phone manager (not shown), configured to manage a voice calling function and/or a video calling function of the electronic device.

The middleware 330 may generate and use a new middleware module by using a combination of functions of the internal element modules. The middleware 330 may provide a module that is specialized based on an OS type, to provide a differentiated function. The middleware 330 may further dynamically delete some elements in existing elements, or may add a new element. Therefore, the middleware 330 may omit some elements in the elements described in the embodiments disclosed in this application, or may include another element, or may replace some of the elements with elements that execute similar functions and have different names.

The API 360 (for example, the API 133) is a set of API programming functions, and may have a different configuration based on the OS. For example, for Android or iOS, one API set may be provided for each platform. For example, for Tizen, two or more API sets may be provided for each platform.

The application 370 (for example, the application 134 in FIG. 2) may include, for example, a pre-loaded application and/or a third-party application. The application 370 (for example, the application 134) may include, for example, a home page application 371, a dialing application 372, an SMS/MMS application 373, an IM application 374, a browser application 375, a camera application 376, an alarm application 377, a contacts application 378, a voice dialing application 379, an e-mail application 380, a calendar application 381, a media player application 382, an album application 383, a clock application 384, and any other appropriate and/or similar application.

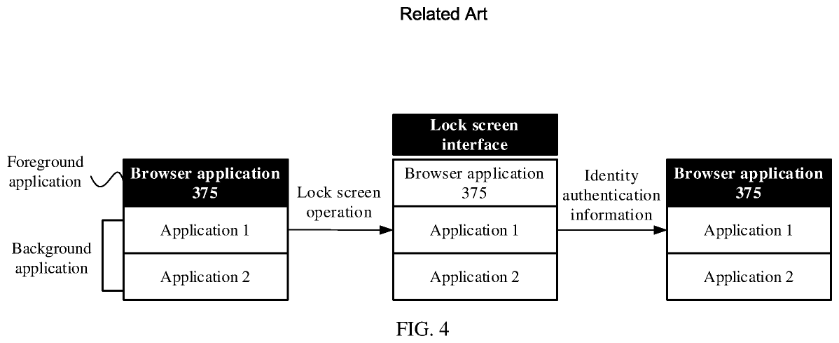

The browser application 375 is used as an example. As shown in FIG. 4, when the browser application 375 is run in the foreground, a corresponding visual output may be presented to the user by using the display module 160. Then, when the user inputs a lock screen operation (for example, a power button is pressed) to the mobile phone 100, or the mobile phone 100 does not receive any input of the user within a preset time, the mobile phone 100 may be triggered to generate a lock screen instruction, and the mobile phone 100 loads a lock screen interface on a current display interface in response to the lock screen instruction, and turns off the screen to enter a black screen state.

In this case, as shown in FIG. 4, the mobile phone 100 may switch the browser application 375 that is run in the foreground to be run in the background, and when the browser application 375 is run in the background, the mobile phone 100 does not provide a visual output for the user, and the mobile phone 100 is still in the black screen state. Subsequently, when the user operates the mobile phone 100, the screen of the mobile phone 100 is turned on, and the lock screen interface is displayed.

Further, when correct identity authentication information (for example, a fingerprint, a face, or a codeword) input by the user is received, it indicates that a user currently operating the mobile phone is an authorized user succeeding in identity authentication. Therefore, as shown in FIG. 4, the mobile phone 100 may switch the lock screen interface, so that the browser application 375 can be run in the foreground. In this case, the mobile phone 100 still presents, to the user, a display interface that is of the browser application 375 and that is presented before the screen is locked.

However, in many application scenarios, intentions of the user for using the terminal before the screen is locked and after the screen is unlocked may be inconsistent. For example, the user uses a video application to watch videos before the screen is locked. However, when receiving a missed call or a message after the screen is locked, a use intention of the user for unlocking the terminal may be: viewing the missed call or the message. For another example, the user uses a social application to chat before the screen is locked. However, when the user inserts a headset into the terminal or connects the terminal to a Bluetooth speaker, a use intention of the user for unlocking the terminal may be: listening to music.

Therefore, if the terminal still displays, to the user after the screen is unlocked, an application (for example, the browser application 375) that is run before the screen is locked, the user needs to first quit the browser application 375, then search for a target application needed by the user, and open the target application. As a result, an application switching process before and after the screen is unlocked is tedious, reducing efficiency of interaction between the terminal and the user.

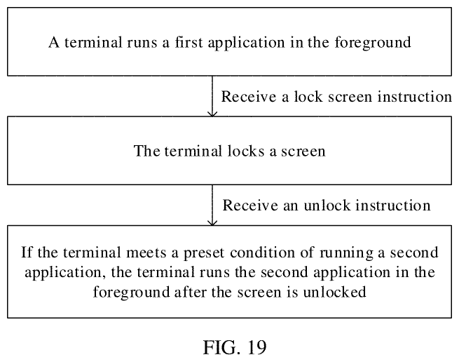

In view of this, in the application switching method provided in the embodiments of this application, as shown in FIG. 19, when a terminal runs a first application in the foreground, the terminal may lock a screen if receiving a lock screen instruction. Subsequently, when the terminal receives an unlock instruction, if the terminal meets a preset condition of running a second application (e.g., the first application is different from the second application), the terminal may run the second application in the foreground after the screen is unlocked.

Specifically, the terminal may collect feature data that is used to reflect a use need of a user from when the screen is locked to when the screen is unlocked, and when the feature data meets the preset condition of running the second application, it indicates that the user wants to open the application or enable a function of the application when the screen of the terminal is unlocked. Then, when receiving the unlock instruction input by the user, the terminal can intelligently, conveniently, and automatically switch, for the user, an application that is run in the foreground from the first application that is run before the screen is locked to the second application needed by the user, to improve efficiency of interaction between the terminal and the user.

The unlock instruction may be generated by the terminal based on identity authentication information, such as a fingerprint or a codeword, that is output by the user and that is preset for unlocking the screen. For a terminal for which no lock screen codeword is set, the unlock instruction may be generated by the terminal based on a gesture or an operation that is input by the user and that is used to wake up the screen of the terminal, for example, a gesture of raising, by the user, a hand, or an operation of pressing, by the user, a power button. This is not limited in this embodiment of this application.

In addition, the preset condition may be specifically one or more of the following plurality of conditions: the terminal in a lock screen state receives a new message related to the second application, the terminal in a lock screen state detects that the terminal is connected to an audio output device (for example, a headset), the terminal in a lock screen state detects that a current location is within a preset geo-fencing, or the terminal in a lock screen state detects that a current time is within a preset time period.

Under each preset condition, when the screen is unlocked, the terminal may automatically run the second application corresponding to the preset condition. The following describes, in detail with reference to a specific application scenario, the application switching method provided in the embodiments of this application under different preset conditions.

It should be noted that when the terminal in the lock screen state meets a plurality of conditions in the preset conditions, for example, the terminal meets a first preset condition of running an application A, a second preset condition of running an application B, and a third preset condition of running an application C, the terminal may randomly select one of the application A, the application B, and the application C as the second application that is run after the screen is unlocked; or the terminal may use, based on a priority sequence preset by the user or a default priority sequence of the terminal, an application having a highest priority in the application A, the application B, and the application C as the second application that is run after the screen is unlocked; or the terminal may determine, based on a use habit of the user, one of the application A, the application B, and the application C as the second application that is run after the screen is unlocked; or the terminal may determine, based on a sequence in which the three preset conditions are met, one of the application A, the application B, and the application C as the second application that is run after the screen is unlocked.

For example, the terminal may use, as the second application that is run after the terminal is unlocked, an application that is used most recently in the application A, the application B, and the application C, or may use, as the second application that is run after the terminal is unlocked, an application that is used most frequently in the application A, the application B, and the application C. This is not limited in this embodiment of this application.

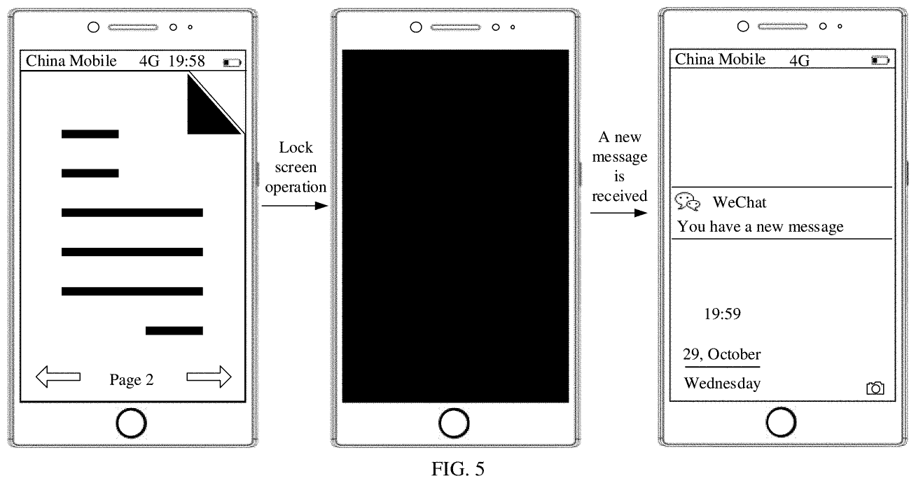

As shown in FIG. 5, before the screen of the terminal is locked, an application that is run by the terminal in the foreground is the first application (for example, an e-book APP). Subsequently, when the terminal receives the lock screen instruction, the terminal locks the screen. The terminal may enter a black screen state when or after the screen is locked, or the terminal may only lock the screen, but does not enter a black screen state. Then, when the screen of the terminal is locked, if the terminal receives a new message related to any installed application (for example, the second application), it may be determined that the terminal meets the preset condition of running the second application. Subsequently, if the terminal receives the unlock instruction, the terminal may automatically run, in the foreground after the screen is unlocked, the second application related to the new message.

The new message may be specifically a short message service message, a missed call notification, an update prompt, an application push message, an advertisement, or the like. This is not limited in this embodiment of this application. The second application is an application to which the new message belongs. For example, a second application to which the short message service message belongs may be specifically a short message service application or an instant messaging application, a second application to which the missed call notification belongs may be specifically a call application, and a second application to which the update prompt, the application push message, and the advertisement belong may be any third-party application.

In addition, that the terminal receives the new message may mean that the terminal receives the new message sent by a server or another terminal, or may mean that a processor of the terminal receives the new message reported by an application or an operating system of the terminal. This is not limited in this embodiment of this application.

Further, the preset condition may further include: a priority of the second application is higher than a priority of the first application. In other words, after the terminal receives the new message, the terminal may further compare the priority of the second application to which the new message belongs and the priority of the first application. When the priority of the second application is higher than the priority of the first application, for example, the second application is a WeChat application having a higher priority, it indicates that the user has a more urgent need of viewing the new message. Therefore, the terminal may determine the second application as an application that is run in the foreground after the screen is unlocked.

Certainly, the terminal may trigger, when the terminal receives identity authentication information input by the user, the terminal to compare the priority of the second application to which the new message belongs and the priority of the first application, and when the priority of the second application is higher than the priority of the first application, the terminal determines the second application as an application that is run in the foreground after the terminal is unlocked.

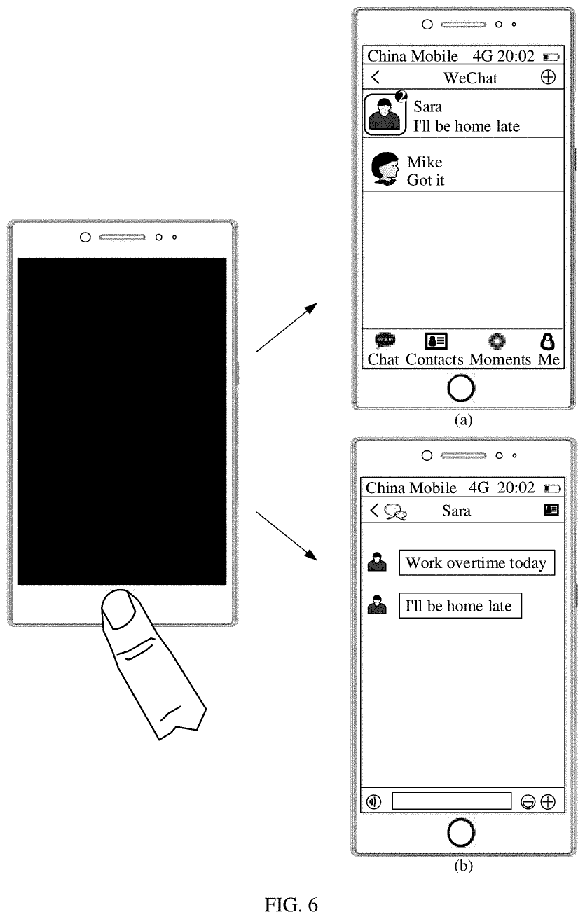

Further, as shown in (a) of FIG. 6, when the identity authentication information input by the user is pre-stored identity authentication information of an authorized user, it indicates that a user currently operating the terminal is an authorized user, and the terminal may automatically switch the second application to be run in the foreground after the screen of the terminal is unlocked. In this case, after the screen of the terminal is unlocked, the terminal may display a preview interface of the new message in the second application to the user.

Alternatively, as shown in (b) of FIG. 6, when the identity authentication information input by the user is pre-stored identity authentication information of an authorized user, the terminal may automatically enter a detail interface of the new message in the second application, so that the user quickly reads the unread new message.

It should be noted that if the second application is run in the background of the terminal when the screen is unlocked, that the terminal switches the second application to be run in the foreground may specifically mean that the terminal switches the second application that is run in the background to be run in the foreground; or if the second application is not run in the terminal when the screen is unlocked, that the terminal switches the second application to be run in the foreground may specifically mean that the terminal automatically opens the second application.

In addition, when the terminal switches the second application to be run in the foreground, the terminal may further kill the first application that is run in the foreground before the screen is locked, or switch the first application that is run in the foreground before the screen is locked to be run in the background. This is not limited in this embodiment of this application.

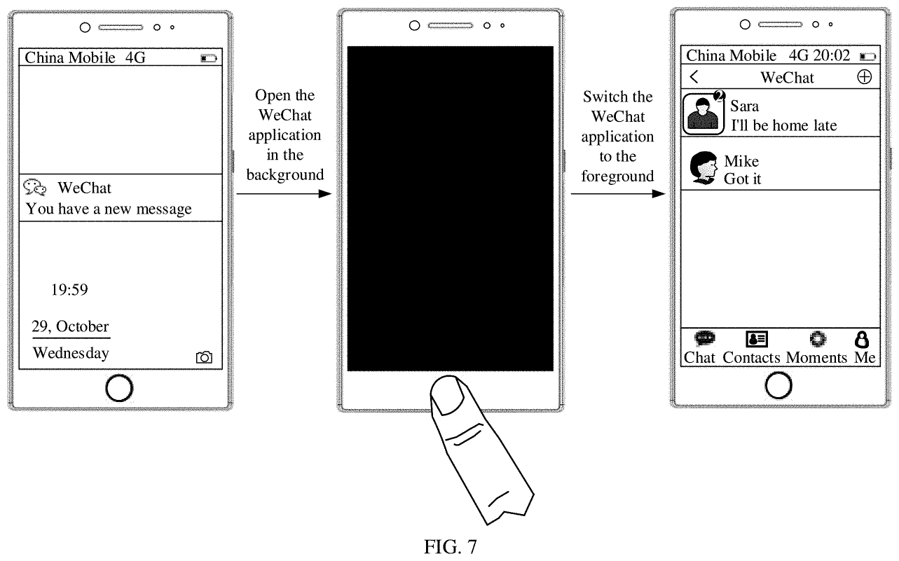

In a possible implementation, as shown in FIG. 7, the terminal may further trigger, after receiving the new message, the terminal to determine whether the second application to which the new message belongs is run in the terminal. If the second application is not run in the terminal, the terminal may automatically open the second application and run the second application in the background of the terminal when the screen of the terminal is in a locked state.

In this way, after receiving correct identity authentication information input by the user, the terminal may automatically switch the second application that is run in the background to be run in the foreground, to reduce a time of waiting for starting of the second application by the user.

In addition, when setting the priorities of the first application and the second application, the terminal may further perform setting by using a specific function, service, or window of an application as a granularity. For example, the following setting is made: a priority of a transfer message in an Alipay application>a priority of an unread message in the WeChat application>a priority of a system notification message in a Taobao application. In other words, the terminal may determine, by using a specific function, service, or window as a granularity, whether a need of the user for opening the second application when the screen is unlocked is urgent, to more appropriately switch, after the screen is unlocked, an application urgently needed by the user to be run in the foreground.

For example, before the screen is locked, the terminal runs an interface of an unread message in the WeChat application in the foreground. Then, if the terminal in the lock screen state receives a transfer message sent to the Alipay application, because the priority of the transfer message in the Alipay application is higher than the priority of the unread message in the WeChat application, after receiving the unlock instruction, the terminal may automatically jump to an interface of the Alipay transfer message having a higher priority.

Similarly, for a same application, the terminal may also set a sequence of priorities of different functions, different services, or different windows of the application. For example, for the WeChat application, the following setting may be made: a priority of a chatting interface>a priority of a contact list interface>a priority of a setting interface.

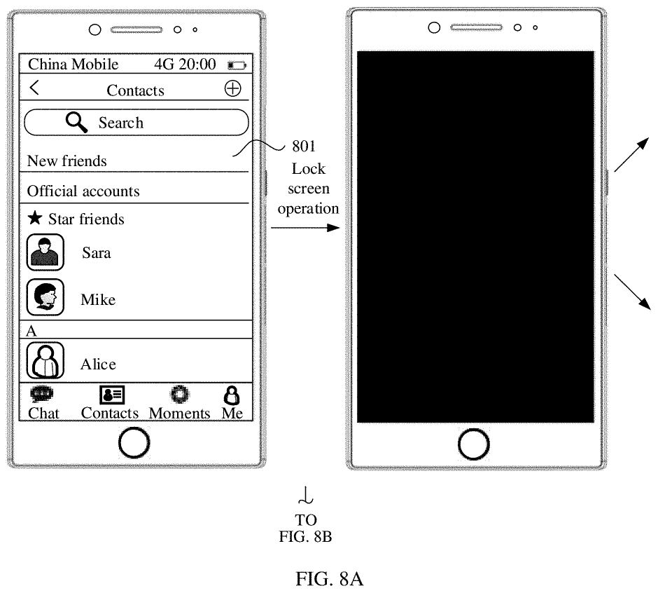

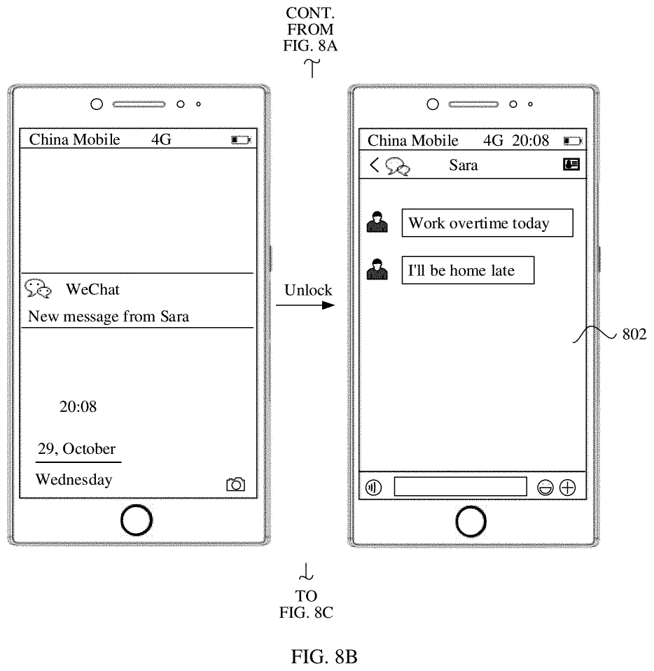

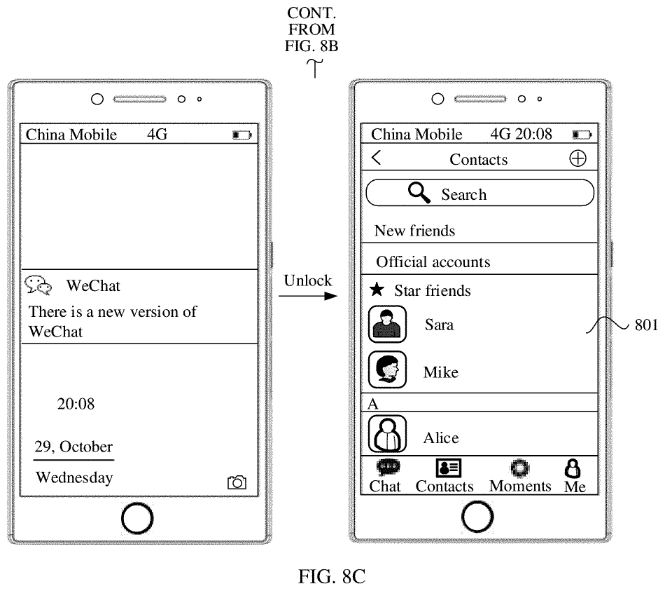

Then, as shown in FIG. 8A, FIG. 8B and FIG. 8C, if the terminal displays a contact list interface 801 of the WeChat application before the screen of the terminal is locked, after the screen is locked, if the terminal receives anew message sent by a friend A, because a priority of a chatting interface 802 to which the new message belongs is higher than a priority of the contact list interface 801, subsequently, after receiving correct identity authentication information input by the user, the terminal may automatically switch from the contact list interface 801 that is run before the screen is locked to the chatting interface 802, so that the user quickly views the new message sent by the friend A.

Correspondingly, still as shown in FIG. 8A, FIG. 8B and FIG. 8C, after the screen is locked, if the terminal receives a system message of updating a WeChat version, because a priority of a setting interface to which the system message belongs is lower than the priority of the contact list interface 801, subsequently, after receiving correct identity authentication information input by the user, the terminal may still continue to display the contact list interface 801, to avoid a case of disturbing the user because the terminal responds to an event of a relatively low user need when the screen is unlocked.

In addition, if the terminal receives, when the screen is locked, a plurality of new messages belonging to different applications, for example, the terminal receives a new message 1 sent by a WeChat friend and an Alipay transfer message 2, after the screen is unlocked, the terminal may jump to an application to which a new message having a higher priority belongs.

For example, when a use frequency of a second application to which a new message belongs is relatively high, the new message may be set to a new message having a relatively high priority; or a new message whose receiving time is the earliest or the latest may be set to a new message having a relatively high priority; or when a second application to which a new message belongs is an application that the user uses recently, the new message may be set to a new message having a relatively high priority. Certainly, a priority of the new message may be preset or randomly selected by the user or the terminal, and this is not limited in this embodiment of this application.

Further, in order to accurately recognize an intention of the user of using the terminal when the screen is unlocked, in addition to the foregoing condition of determining the priority, the terminal may further set one or more other determining conditions of triggering the terminal to automatically switch to the second application for the user when the screen is unlocked.

For example, the terminal may further set effective duration of switching to the second application by the terminal. Then, the terminal may determine, based on the effective duration, whether to switch from the first application that is run before the screen is locked to the second application to which the new message belongs, and when determining to switch to the second application, the terminal may further determine, based on the effective duration, a specific interface of the second application to which the terminal switches.

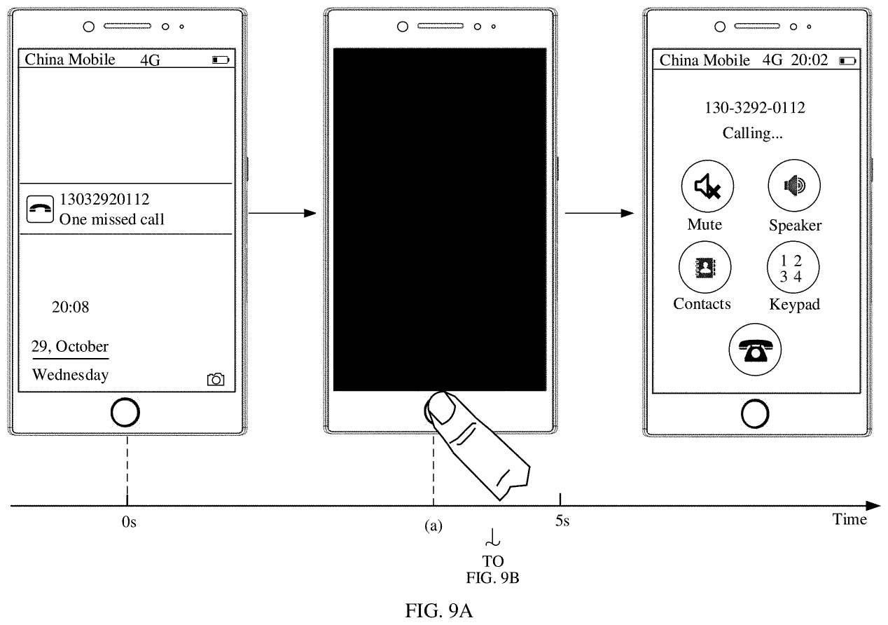

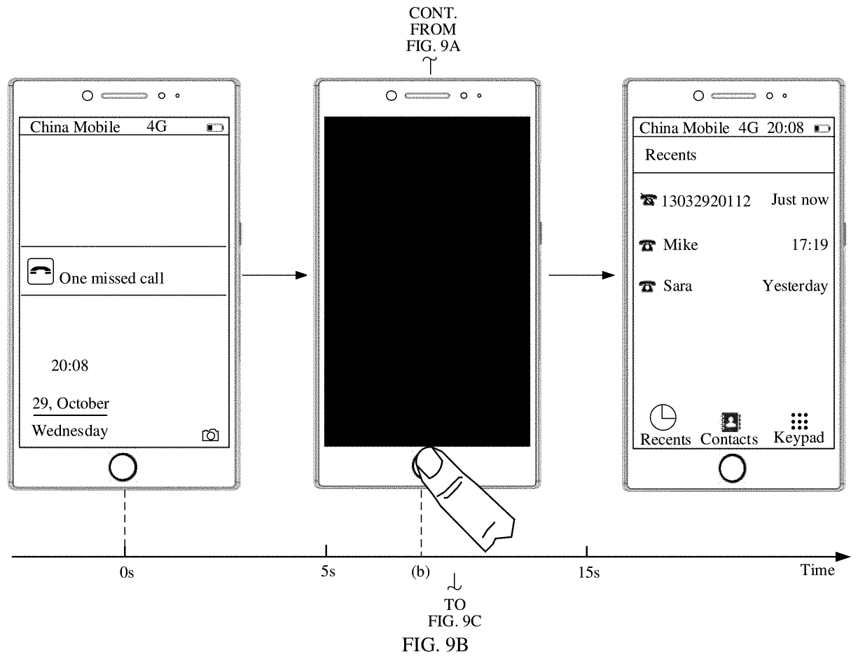

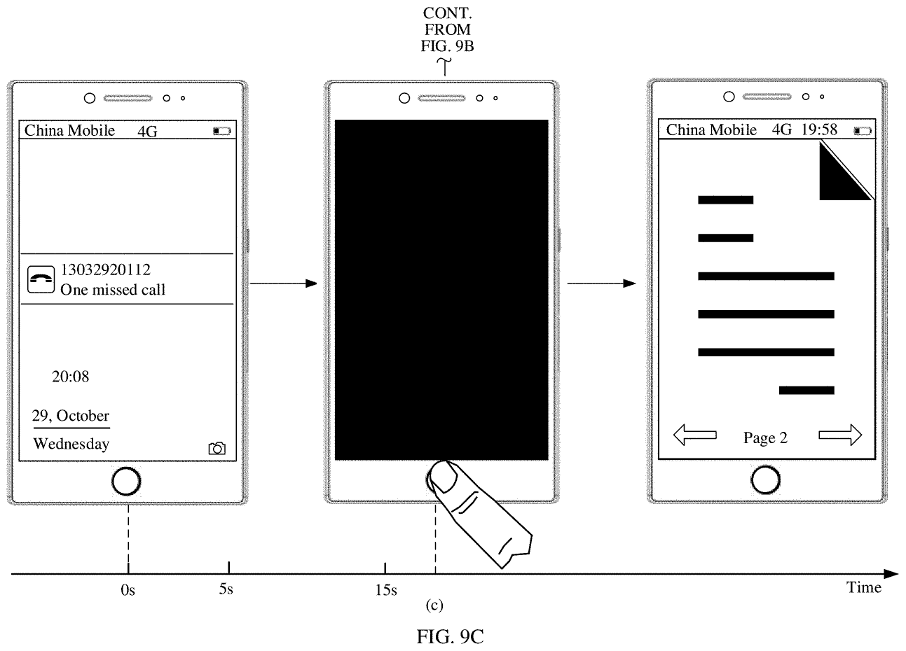

For example, first effective duration of switching to the second application by the terminal is within 5 s after a new message is received. If the user unlocks the terminal within 5 s after a new message is received, it indicates that the user has a very obvious use intention of replying to the new message. Therefore, as shown in (a) of FIG. 9A, FIG. 9B and FIG. 9C, when the screen of the terminal is locked, if the terminal receives a missed call notification, the terminal may use a first moment of receiving the missed call notification as a start moment to start a first timer whose duration is 5 seconds. If the terminal receives, before a second moment at which the first timer expires, correct identity authentication information input by the user, the terminal may automatically dial a number of a calling party of the missed call after the screen is unlocked. In this case, the terminal switches from the first application that is run before the screen is locked to a calling interface (namely, a first interface of the second application) of a dialing application to which the missed call notification belongs.

Further, second effective duration of switching to the second application by the terminal may be further set to be within 5 s to 15 s after a new message is received. If the user unlocks the terminal within 5 s to 15 s after a new message is received, it indicates that the user has a relatively obvious use intention of replying to the new message. Therefore, as shown in (b) of FIG. 9A, FIG. 9B and FIG. 9C, the terminal receives a missed call notification when the screen of the terminal is locked. When the first timer expires, the terminal may use a second moment at which the first timer expires as a start moment to start a second timer whose duration is 10 seconds. If the terminal receives, before a third moment at which the second timer expires, correct identity authentication information input by the user, the terminal may automatically switch to an interface (namely, a second interface of the second application) of recent calls of the dialing application after the screen is unlocked, so that the user further processes the missed call.

Correspondingly, as shown in (c) of FIG. 9A, FIG. 9B and FIG. 9C, if the terminal receives, after 15 s after the new message is received, correct identity authentication information input by the user, it indicates that the user has a relatively weak intention of viewing the new message. In this case, the terminal may continue to run, in the foreground, the first application that is run before the screen is locked.

For example, the terminal may further set an effective period of switching to the second application by the terminal. For example, the following setting may be made: When the screen is locked, each time after the terminal receives a new message, if the user inputs correct identity authentication information, the terminal is triggered to automatically switch from the first application that is run before the screen is locked to the second application to which the new message belongs. Alternatively, the following setting may be made: If the terminal in a lock screen state receives a new message within a time period (for example, after-work hours 18:00 to 24:00 everyday), the terminal is allowed to automatically switch from the first application that is run before the screen is locked to the second application to which the new message belongs.

Certainly, the determining condition may be pre-stored in the terminal, or may be manually set by the user, or may be obtained by the terminal from a server, or certainly may be automatically generated by the terminal based on a use habit of the user by using an artificial intelligence algorithm. This is not limited in this embodiment of this application.

In some embodiments of this application, when the terminal runs the first application in the foreground, if the terminal receives the lock screen instruction, the terminal may lock the screen. If the terminal in the lock screen state detects that the terminal is connected to an audio output device, it indicates that the terminal meets a preset condition of running an application supporting audio playback. Therefore, if the terminal receives the unlock instruction, the terminal may unlock the screen of the terminal, and run, in the foreground, the application supporting audio playback.

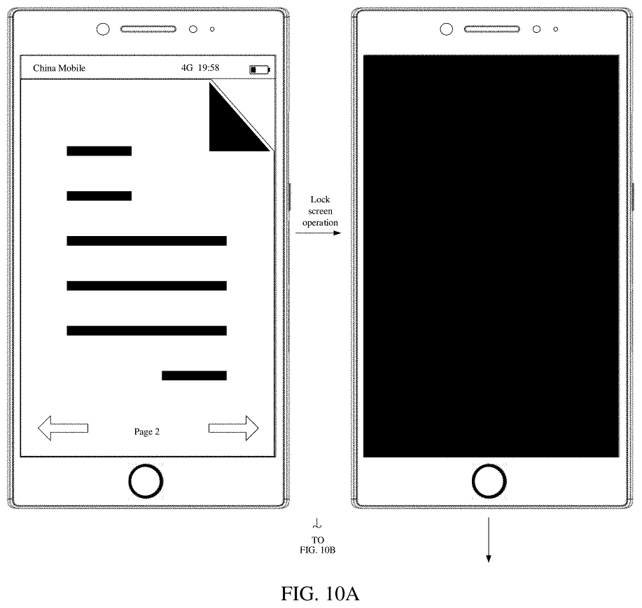

As shown in FIG. 10A and FIG. 10B, before the screen of the terminal is locked, an application that is run by the terminal in the foreground is the first application (for example, an e-book APP). Subsequently, when the terminal receives the lock screen instruction input by the user, the terminal locks the screen. The terminal may enter a black screen state when or after the screen is locked, or the terminal may only lock the screen, but does not enter a black screen state.

Then, if the terminal detects, when the screen is locked, an event of inserting a headset or connecting to a speaker or the like, it indicates that the user has an audio playback intention of listening to music or listening to books or the like. Therefore, the terminal may determine the installed application supporting audio playback as the second application that is run in the foreground after the screen is unlocked. In other words, the preset condition of running the second application is: the terminal in the lock screen state detects that the terminal is connected to the audio output device.

Certainly, the terminal may be triggered, when the terminal receives identity authentication information (for example, a codeword, a fingerprint, or the like input by the user) input by the user, to detect whether a headset is inserted or a speaker is connected. When the terminal is connected to the headset or the speaker, an installed audio application may be determined as the second application that is run in the foreground after the screen is unlocked.

Further, as shown in FIG. 10A and FIG. 10B, when the identity authentication information input by the user is pre-stored identity authentication information of an authorized user, it indicates that a user currently operating the terminal is an authorized user, and the terminal may automatically switch the audio application to be run in the foreground after the screen of the terminal is unlocked. In this case, the terminal displays a display interface of the audio application (namely, the second application) to the user after the screen of the terminal is unlocked.

Further, the preset condition of running the application supporting audio playback may further include: a priority of the application supporting audio playback is higher than a priority of the first application. In other words, if the terminal detects, when the screen is locked, that the terminal is connected to the audio output device, the terminal may further determine whether a priority of the second application that is determined to be run after the screen is unlocked is higher than the priority of the first application that is run before the screen is locked. When the priority of the second application is higher than the priority of the first application that is run before the screen is locked, after the screen is unlocked, the terminal jumps to the application supporting audio playback; or otherwise, the terminal may continue to run the first application in the foreground after the screen is unlocked.

For example, after the screen is unlocked, the terminal may jump to a display interface of a program or song that the user recently listens to in the second application, so that it is convenient for the user continues to listen to the program or song after the screen is unlocked.

In addition, if the terminal installs a plurality of second applications supporting audio playback, for example, NetEase music, Qingting FM, or QQ music, if the terminal detects, when the screen is locked, that the terminal is connected to the audio output device, after the screen is unlocked, the terminal may jump to a second application having a relatively high priority.

For example, when a use frequency of a second application supporting audio playback is relatively high, the application may be set to a second application having a relatively high priority; or when a second application supporting audio playback is an application that the user uses recently, the application may be set to a second application having a relatively high priority. Certainly, the priority of the second application supporting audio playback may be preset or randomly selected by the user or the terminal, and this is not limited in this embodiment of this application.

Similarly, when the terminal switches the second application to be run in the foreground, the terminal may further kill the first application that is run in the foreground before the screen is locked, or switch the first application that is run in the foreground before the screen is locked to be run in the background. This is not limited in this embodiment of this application.

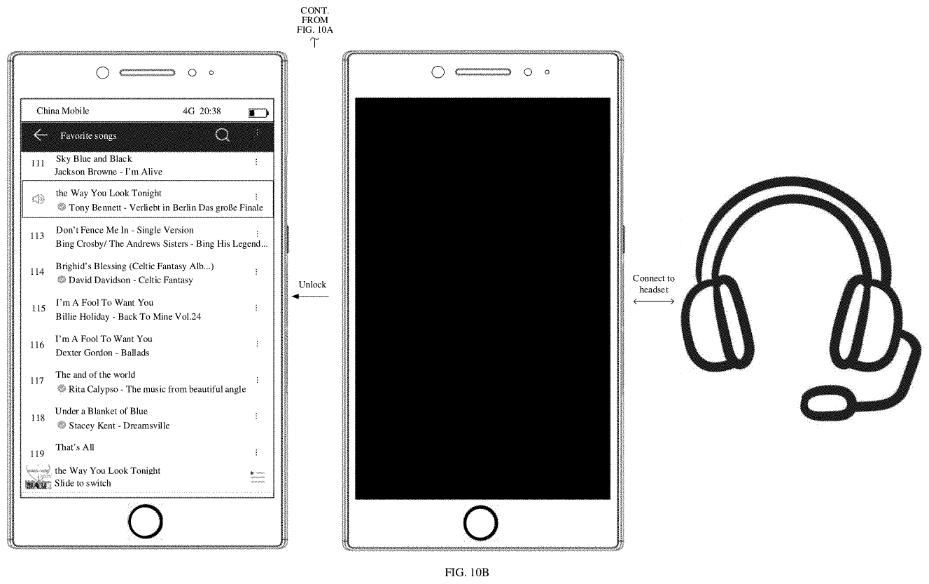

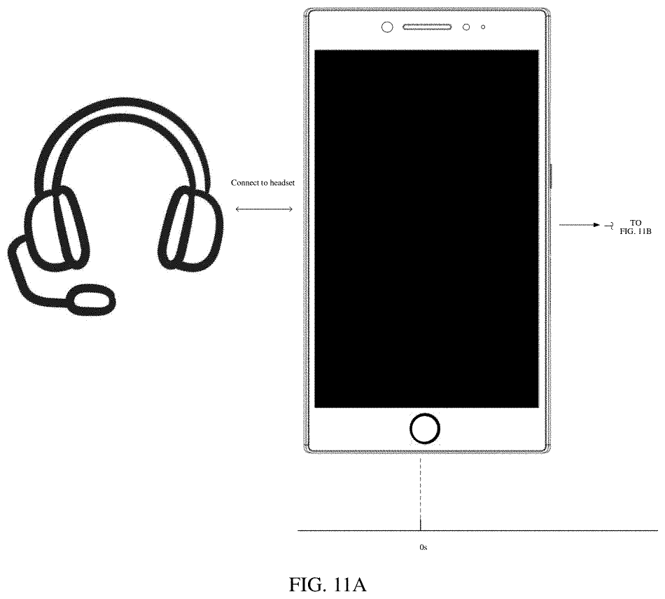

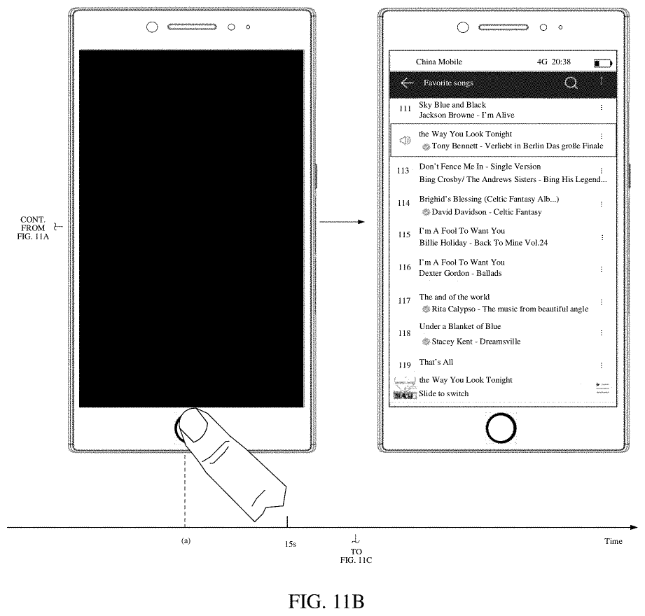

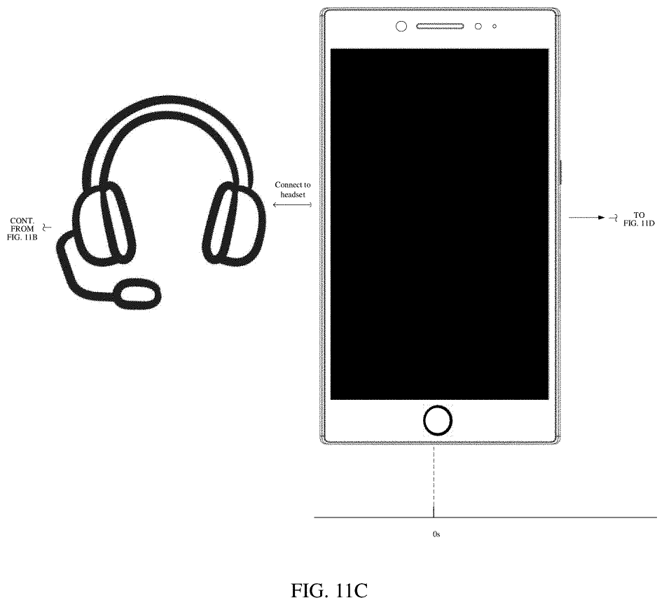

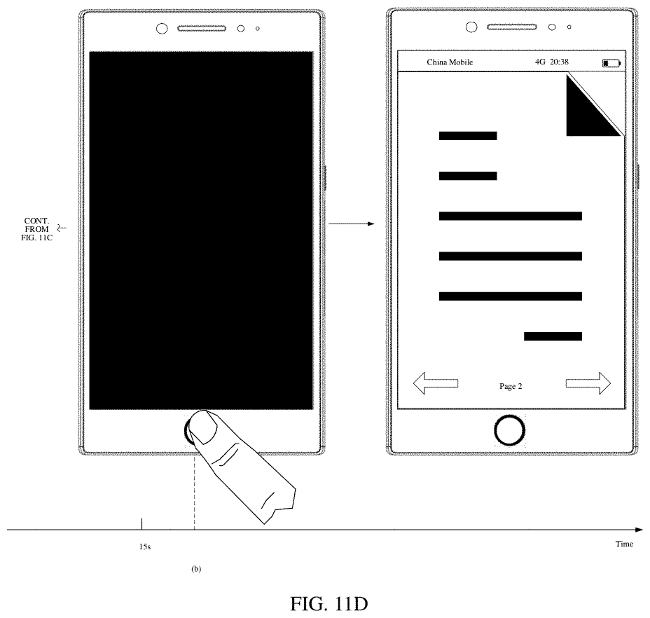

Further, as shown in FIG. 11A, FIG. 11B, FIG. 11C and FIG. 11D, the terminal may further set effective duration of switching to the second application by the terminal. For example, the effective duration of switching to the second application by the terminal is set to be within 15 s after it is detected that the headset is inserted, and if the user unlocks the terminal within 15 s after the headset is inserted, it indicates that the user has a relatively obvious intention of listening to audio by using the headset. Therefore, as shown in (a) of FIG. 11A, FIG. 11B, FIG. 11C and FIG. 11D, when the screen of the terminal is locked, if the terminal receives, within 15 s after it is detected that the headset is inserted, correct identity authentication information input by the user, the terminal may automatically switch the second application to be run in the foreground after the screen is unlocked.

Correspondingly, as shown in (b) of FIG. 11A, FIG. 11B, FIG. 11C and FIG. 11D, when the screen of the terminal is locked, if the terminal receives, after 15 s after it is detected that the headset is inserted, correct identity authentication information input by the user, after the screen is unlocked, the terminal may continue to run, in the foreground, the first application that is run before the screen is locked.

For example, the terminal may further set an effective period of switching to the second application by the terminal. For example, when the user is at home, the terminal is automatically connected to a Bluetooth speaker in the home. Then, each time when the user unlocks the terminal, it may be detected that the terminal is in a state of being connected to the Bluetooth speaker. If the terminal automatically switches to the second application of an audio type each time when the screen is unlocked, use experience of the user is affected. Therefore, the effective period may be set to 4 hours. In this way, as shown in FIG. 12A and FIG. 12B, within each effective period, if the terminal detects, for the first time, that the terminal is connected to the Bluetooth speaker when the screen is locked, the terminal may automatically switch the second application to be run in the foreground after the screen is unlocked. Subsequently, if the terminal detects, again within the four hours, that the terminal is connected to the Bluetooth speaker when the screen is locked, the terminal may continue to run, in the foreground after the screen is unlocked, the first application that is run before the screen is locked.

Alternatively, the effective period may be an entire time period from when the terminal is connected to the Bluetooth speaker to when the terminal is disconnected from the Bluetooth speaker. Then, the terminal only needs to automatically switch the second application to be run in the foreground when receiving the unlock instruction for the first time after the terminal is connected to the Bluetooth speaker, to avoid a case of causing inconvenience to the user because the terminal frequently jumps to the second application when the screen is unlocked.

In addition, the terminal may further learn and correct, based on a use habit of the user, a condition of determining whether to switch to the second application when the screen is unlocked. For example, after the user inserts the headset when the screen is locked, the screen is unlocked. In this case, the terminal automatically switches the second application to be run in the foreground. Then, if it is detected that the user quits the second application for successive two times after the screen is unlocked, it indicates that a use intention of the user after the screen is unlocked is not using the second application. Therefore, when the terminal detects, again when the screen is locked, that the user inserts the headset, if the user inputs correct identity authentication information to unlock the screen, the terminal may continue to run, in the foreground, the first application that is run before the screen is locked.

For another example, the terminal may further collect and collect statistics on data such as a time, a location, or a motion state of using the second application by the user, to determine a preset condition of using the second application by the user. For example, the user has a habit of listening to music before sleep (for example, 10:30 to 11:00 PM), or the user has a habit of listening to music when driving. Then, if the terminal in the lock screen state detects, at 10:30 to 11:00 PM or when it is determined that the user is driving, that the user inserts a headset or the terminal is connected to a speaker, the terminal may automatically switch the second application of the audio type to be run in the foreground when the screen is unlocked, to provide customized application switching experience for the user.

In some other embodiments of this application, when the terminal runs the first application in the foreground, if the terminal receives the lock screen instruction, the terminal may lock the screen. If the terminal in the lock screen state detects that a current location of the terminal is within a preset geo-fencing, and/or the terminal in the lock screen state detects that a current time is within a preset time period, it indicates that the terminal meets the preset condition of running the second application. Therefore, if the terminal receives the unlock instruction, the terminal may unlock the screen of the terminal, and run the second application in the foreground.

In other words, the preset condition of automatically running the second application by the terminal after the screen is unlocked may be: the terminal in the lock screen state detects that the current location of the terminal is within the preset geo-fencing, and/or the terminal in the lock screen state detects that the current time is within the preset time period.

An example in which the second application is an attendance tracking APP (e.g., APPs for attendance) is used. When the terminal runs the first application in the foreground, if the terminal receives the lock screen instruction, the terminal may lock the screen. If the terminal in the lock screen state detects that a current location of the terminal is near a preset clock-in/out location and a current time is within a clock-in/out time period, it indicates that the terminal meets a preset condition of running the attendance tracking application. Therefore, if the terminal receives the unlock instruction, the terminal may unlock the screen of the terminal, and run the attendance tracking application in the foreground.

In other words, when the second application is an attendance tracking application, the preset geo-fencing may be specifically near the preset clock-in/out location, and the preset time period may be specifically the preset clock-in/out time period.

For example, the terminal may obtain, through learning in a manner of collecting information about locations at which the user is located at different times, clock-in/out times at which the user needs to clock in/out (for example, clock-in hours and clock-out hours). For example, the clock-in hours of the user are 8:00 to 9:00 from Monday to Friday, and the clock-out hours of the user are 17:30 to 18:30 from Monday to Friday.

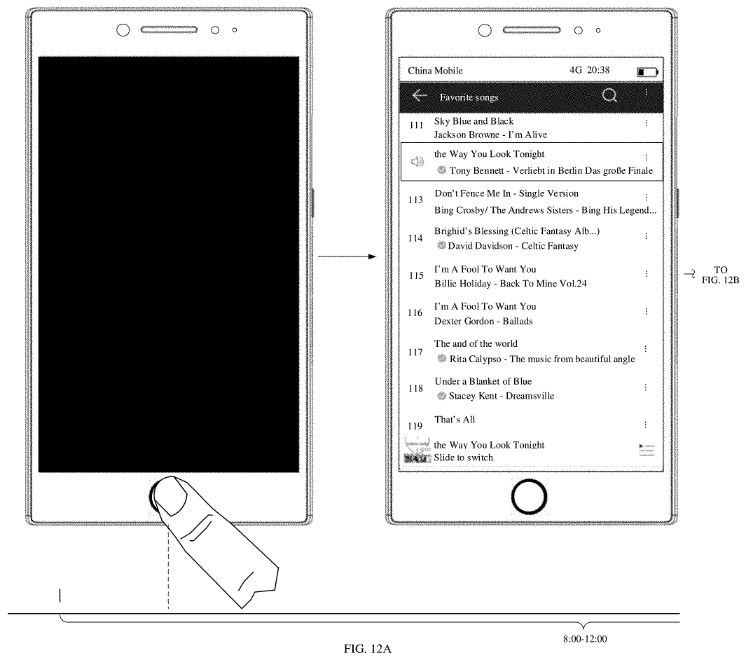

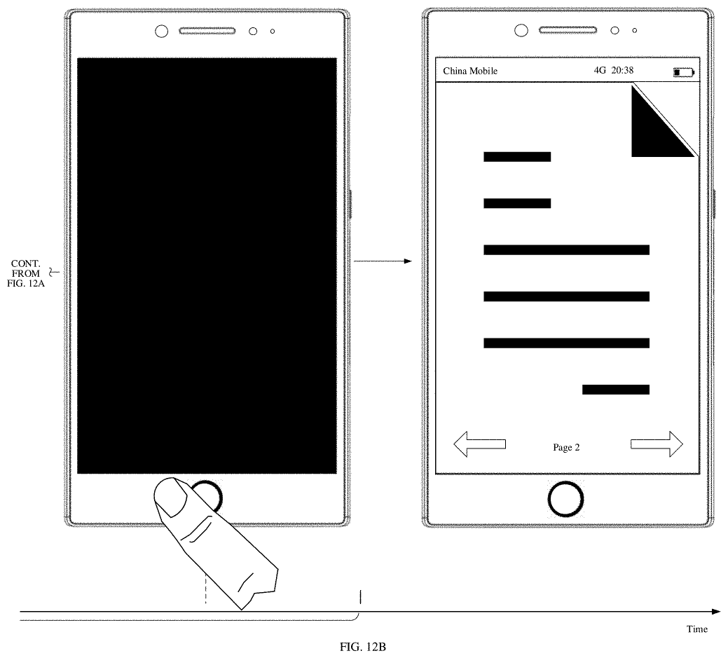

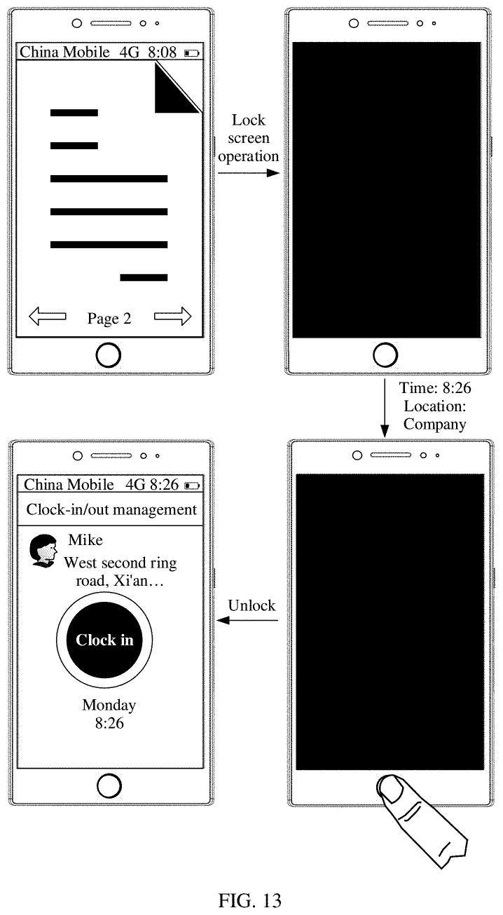

Then, as shown in FIG. 13, after the screen of the terminal is locked, the terminal may further detect location information of the user during the clock-in hours or the clock-out hours, and if detecting that the user is near the clock-in/out location (for example, a company), the terminal may determine an installed attendance tracking application (for example, a clock-in/out application) as an application that is run in the foreground after the terminal is unlocked.

Further, as shown in FIG. 13, when identity authentication information input by the user is pre-stored identity authentication information of an authorized user, it indicates that a user currently operating the terminal is an authorized user, and the terminal may automatically switch the attendance tracking application or the clock-in/out application to be run in the foreground after the screen of the terminal is unlocked, to prompt the user to clock in or clock out.

Further, the preset condition of running the attendance tracking application may further include: a priority of the attendance tracking application is higher than a priority of the first application. In other words, if the terminal detects, when the screen is locked, that a current location of the terminal is near the preset clock-in/out location and a current time is within the clock-in/out time period, the terminal may further determine whether the priority of the attendance tracking application is higher than the priority of the first application that is run before the screen is locked. When the priority of the attendance tracking application is higher than the priority of the first application that is run before the screen is locked, the terminal jumps to the attendance tracking application after the screen is unlocked; or otherwise, the terminal may continue to run the first application in the foreground after the screen is unlocked.

For example, when the terminal detects, within the clock-in hours or the clock-out hours, that the user is near the company, a quantity of times that the terminal switches to the attendance tracking application or the clock-in/out application after the screen is unlocked may be one. In other words, when the user unlocks the terminal during the clock-in hours or the clock-out hours, the terminal prompts the user to clock in/out by using only one application switching operation, to avoid a case of disturbing the user because the clock-in/out application is frequently displayed when the user unlocks the terminal during the clock-in hours or the clock-out hours.

Alternatively, if it is detected, within the clock-in hours or clock-out hours, that the user is near the company, after the terminal switches to the attendance tracking application or the clock-in/out application after the screen is unlocked, the terminal may further continue to detect whether the user performs a clock-in/out operation. If it is detected that the user performs the clock-in/out operation, the terminal does not switch to the attendance tracking application or the clock-in/out application again when the screen is unlocked subsequently. Correspondingly, if the terminal does not detect that the user performs the clock-in/out operation, for example, the user quits the clock-in/out application, the terminal may continue to switch to the attendance tracking application or the clock-in/out application when the screen is unlocked subsequently, until it is detected that the user performs the clock-in/out operation, to prevent the user from forgetting to clock in/out.

In addition, if a plurality of attendance tracking applications are installed in the terminal, if the terminal detects, when the screen is locked, that a current location of the terminal is near the preset clock-in/out location and a current time is within the clock-in/out time period, after the screen is unlocked, the terminal may jump to an attendance tracking application having a relatively high priority.

For example, when a use frequency of an attendance tracking application is relatively high, the application may be set to an attendance tracking application having a relatively high priority; or when an attendance tracking application is an application that the user uses recently, the application may be set to an attendance tracking application having a relatively high priority. Certainly, the priority of the attendance tracking application may be preset or randomly selected by the user or the terminal, and this is not limited in this embodiment of this application.

An example in which the second application is a game or reading application is used. When the terminal runs the first application in the foreground, if the terminal receives the lock screen instruction, the terminal may lock the screen. If the terminal in the lock screen state detects that a current location of the terminal is a historical location at which the user uses the second application and a current time is within a historical time at which the user uses the second application, it indicates that the terminal meets a preset condition of running the game or reading application. Therefore, if the terminal receives the unlock instruction, the terminal may unlock the screen of the terminal, and run the game or reading application in the foreground.

In other words, when the second application is the game or reading application, the preset geo-fencing may be specifically the historical location at which the user uses the second application, and the preset time period may be specifically the historical time at which the user uses the second application.

For example, the terminal may determine, by obtaining a user persona of the user or collecting behavior data used to reflect a user behavior feature, use intentions of the user when the user unlocks the screen at different times, at different locations, or in different scenarios. Further, when the user unlocks the screen of the terminal at a corresponding time, at a corresponding location, or in a corresponding scenario, the terminal may automatically switch to an application conforming to a use intention of the user or a corresponding function of the application, so that the user can conveniently and accurately performs application switching before and after the screen is locked, to implement efficient interaction between the user and the terminal.

The user persona usually includes one or more tags of the user (for example, gender, a habit of staying up late, or a reading preference), the user persona may reflect an information overview of the user, and the terminal may predict a current possible behavior or hobby of the user by using the user persona.

For example, as shown in FIG. 14, the user persona of the user indicates that the user has a habit of enjoying entertainment before sleep, and a sleep time of the user is 23:00 to 7:30. Then, the terminal may determine, as using a game application B based on the user persona, a use intention of the user when the user unlocks the terminal between 22:00 and 23:00 (before sleep). Therefore, if it is detected, between 22:00 and 23:00, that the user inputs correct identity authentication information to the terminal to unlock the screen, the terminal may automatically open the game application B after the screen is unlocked, or the terminal may automatically switch the game application B that is run in the background to be run in the foreground after the screen is unlocked.

For another example, the user persona of the user indicates that the user has a habit of reading before sleep, and a sleep time of the user is 23:00 to 7:30. Then, the terminal may determine, as using a reading application based on the user persona, a use intention of the user when the user unlocks the terminal between 22:00 and 23:00. Therefore, if it is detected, between 22:00 and 23:00, that the user inputs correct identity authentication information to the terminal to unlock the screen, the terminal may automatically open the reading application after the screen is unlocked, or the terminal may automatically switch the reading application that is run in the background to be run in the foreground after the screen is unlocked.

Further, the preset condition of running the game or reading application may further include: a priority of the game or reading application is higher than the priority of the first application. In other words, if the terminal detects, when the screen is locked, that a current location of the terminal is a historical location at which the user uses the game or reading application and a current time is within a historical time at which the user uses the game or reading application, the terminal may further determine whether the priority of the game or reading application is higher than the priority of the first application that is run before the screen is locked. When the priority of the game or reading application is higher than the priority of the first application that is run before the screen is locked, the terminal jumps to the game or reading application after the screen is unlocked; or otherwise, the terminal may continue to run the first application in the foreground after the screen is unlocked.

An example in which the second application is an application including an e-ticket is used. When the terminal runs the first application in the foreground, if the terminal receives the lock screen instruction, the terminal may lock the screen. If the terminal in the lock screen state detects that a current location of the terminal is near a station, it indicates that the terminal meets a preset condition of running the application including an e-ticket. Therefore, if the terminal receives the unlock instruction, the terminal may unlock the screen of the terminal, and run the application including an e-ticket in the foreground.

In other words, when the second application is the application including an e-ticket, the preset geo-fencing may be specifically a station such as a subway station, a bus station, or a railway station. The e-ticket may be a virtual certificate (for example, a two-dimensional code, or a short message service message) obtained by using a network, and is used to replace an original paper ticket (for example, a bus ticket, a railway ticket, or a bus card) for boarding or exiting a station.

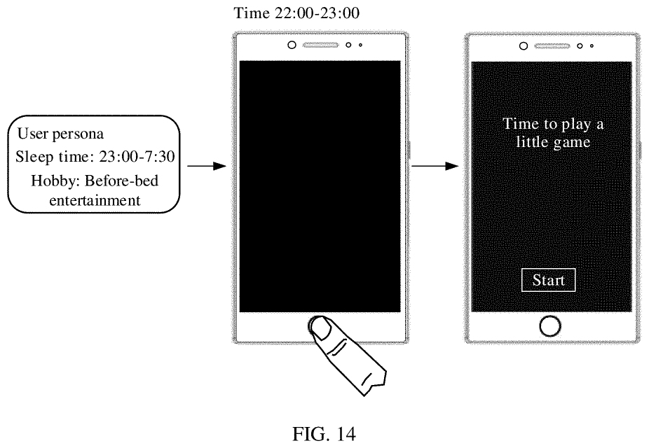

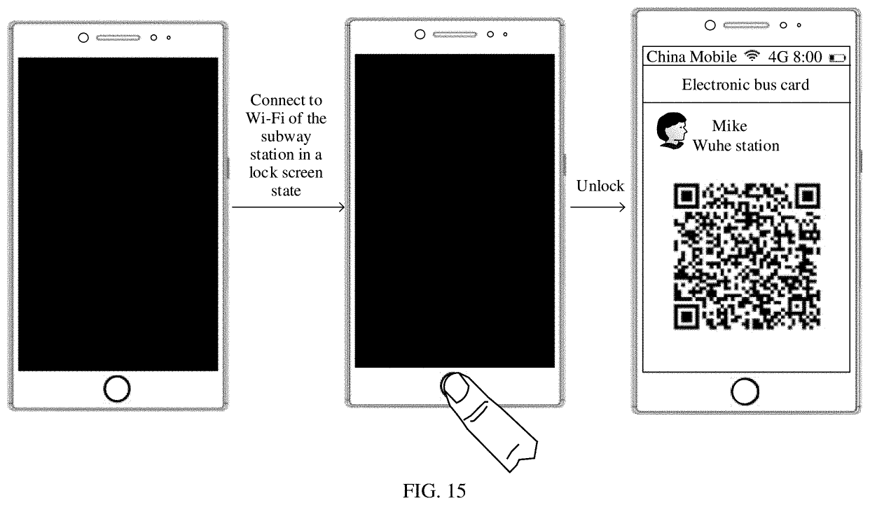

The terminal may determine a current location of the user by using various positioning manners. For example, the terminal may determine, by detecting an identifier such as a service set identifier (SSID) of a current Wi-Fi network, whether the user is at the subway station. As shown in FIG. 15, when determining that the user is at the subway station, if detecting that the user inputs correct identity authentication information to the terminal to unlock the screen, the terminal may automatically enable an NFC function and display a card swiping certificate such as an electronic bus card after the screen is unlocked, so that the user quickly swipes the card to exit the station.

Further, when determining that the user is at the subway station, the terminal may further detect a current motion state of the user. When determining that the user is in a walking state, if receiving correct identity authentication information input by the user to the terminal, the terminal may automatically enable the NFC function and display the card swiping certificate such as the electronic bus card after the screen is unlocked, to avoid a case of disturbing the user because the terminal displays the electronic bus card when the screen is unlocked in a scenario in which the user is in a bus and does not need to swipe a card to exit the station.

Further, the preset condition of running the application including an e-ticket may further include: a priority of the application including an e-ticket is higher than the priority of the first application. In other words, if the terminal detects, when the screen is locked, that a current location of the terminal is near the station, the terminal may further determine whether the priority of the application including an e-ticket is higher than the priority of the first application that is run before the screen is locked. When the priority of the application including an e-ticket is higher than the priority of the first application that is run before the screen is locked, the terminal jumps to the application including an e-ticket after the screen is unlocked; or otherwise, the terminal may continue to run the first application in the foreground after the screen is unlocked.

Certainly, the user may preset a shortcut gesture of quickly entering an application or a function when the screen is unlocked. For example, a correspondence between a gesture of knocking, by an interphalangeal joint, the screen and a payment interface of the Alipay application may be set. Then, when the screen is locked, if the terminal detects that the user knocks the screen by using the interphalangeal joint, the terminal may first display an unlock interface of prompting the user to input identity authentication information, and after the user inputs correct identity authentication information, the terminal may be unlocked and automatically display the payment interface of the Alipay application, to quickly enable a payment function of the Alipay application when the user unlocks the screen.

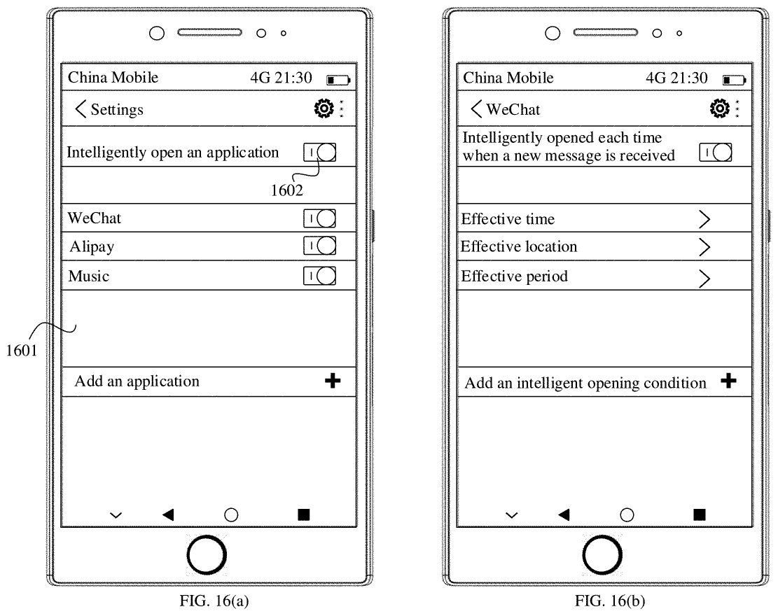

Further, as shown in FIG. 16(a), the terminal may provide, on a setting interface 1601, a setting function 1602 of intelligently opening each application when the screen is unlocked. When the user enables the setting function 1602, the user may further select a specific application that is allowed to be intelligently opened when the screen is unlocked.

An example in which the terminal is allowed to intelligently open the WeChat application when the screen is unlocked is used. A condition of determining whether to open the WeChat application may be preset or automatically generated by the terminal, or may be manually set by the user. For example, as shown in FIG. 16(b), after the user allows to intelligently open the WeChat application when the screen is unlocked, determining conditions, such as a time, a location, and an effective period, of intelligently opening the WeChat application may be set. Subsequently, when the terminal in the lock screen state detects that the terminal meets the determining conditions, the terminal may automatically open the WeChat application or a related function of the WeChat application for the user after the screen is unlocked, to simplify an application switching process before and after the screen is unlocked, and improve efficiency of interaction between the terminal and the user.

It may be understood that, to implement the foregoing functions, the terminal includes a corresponding hardware structure and/or software module for executing the functions. A person of ordinary skill in the art should appreciate that units, algorithms, and steps in examples described with reference to the embodiments disclosed in this specification may be implemented by hardware or a combination of hardware and computer software. Whether a function is executed by hardware or hardware driven by computer software depends on particular applications and design constraints of the technical solutions. A person skilled in the art may use different methods to implement the described functions for each particular application, but it should not be considered that the implementation goes beyond the scope of the embodiments of this application.

In the embodiments of this application, functional modules of the terminal may be divided based on the foregoing method example. For example, each functional module may be divided based on each function, or two or more functions may be integrated into one processing module. The integrated module may be implemented in a form of hardware, or may be implemented in a form of a software functional module. It should be noted that, in this embodiment of this application, module division is an example, and is merely a logical function division. In actual implementation, another division manner may be used.

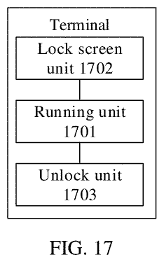

When the functional modules are divided by using the corresponding functions, FIG. 17 is a possible schematic structural diagram of a terminal used in the foregoing embodiment. The terminal includes a running unit 1701, a lock screen unit 1702, and an unlock unit 1703.

The running unit 1701 is configured to run a first application in the foreground. The lock screen unit 1702 is configured to lock a screen of the terminal in response to a lock screen instruction. The unlock unit 1703 is configured to: when the terminal meets a preset condition of running a second application, unlock the screen of the terminal in response to an unlock instruction. The running unit 1701 is further configured to run the second application in the foreground, where the first application is different from the second application.

For example, the preset condition includes: the terminal in a lock screen state receives a new message related to the second application, where the new message includes at least one of a short message service message, a missed call notification, an instant messaging message, an application update prompt, a push message, and an advertisement message. The running unit 1701 is configured to: run a detail interface of the new message in the second application in the foreground; or run a preview interface of the new message in the second application in the foreground.

Further, the new message is received by the terminal at a first moment, and the running unit 1701 is configured to: if the terminal obtains the unlock instruction at a moment between the first moment and a second moment, run a first interface of the second application in the foreground, where the second moment is later than the first moment; and if the terminal obtains the unlock instruction at a moment between the second moment and a third moment, run a second interface of the second application in the foreground, where the third moment is later than the second moment.

Further, the running unit 1701 is further configured to continue to run the first application in the foreground if the terminal obtains the unlock instruction after the third moment.

Further, the running unit 1701 is configured to: run a first interface of the first application in the foreground; and when a priority of a target interface to which the new message belongs is higher than a priority of the first interface, run the target interface of the second application in the foreground.

For example, the preset condition includes: the terminal in the lock screen state detects that the terminal is connected to an audio output device; the second application is an application supporting audio playback; and the running unit 1701 is configured to run the second application in the foreground if the terminal in a state of being connected to the audio output device receives the unlock instruction for the first time.

For example, the preset condition includes any one or two of the following: the terminal in the lock screen state detects that a current location is within a preset geo-fencing, or the terminal in the lock screen state detects that a current time is within a preset time period. When the second application is an attendance tracking application, the preset geo-fencing is near a preset clock-in/out location, and the preset time period is a preset clock-in/out time period. When the second application is a game or reading application, the geo-fencing is a historical location at which the user uses the second application, and the preset time period is a historical time at which the user uses the second application. When the second application is an application including an e-ticket, the preset geo-fencing is a station.

All related content of each step in the foregoing method embodiment may be cited in function descriptions of a corresponding functional module.

When an integrated unit is used, the running unit 1701, the lock screen unit 1702, and the unlock unit 1703 may be integrated into a processing module. Certainly, the terminal may further include a storage module, a communications module, an input/output module, and the like.

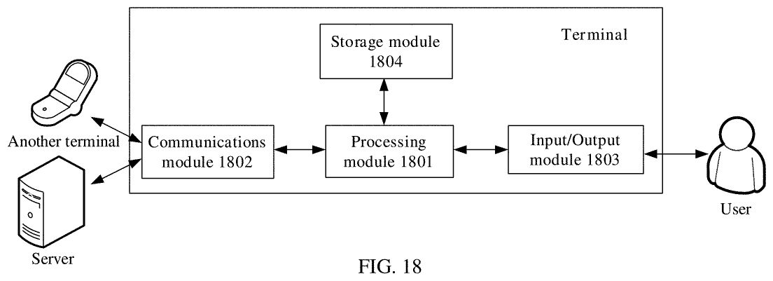

In this case, FIG. 18 shows a possible schematic structural diagram of a terminal used in the foregoing embodiment. The processing module 1801 is configured to control and manage behavior of the terminal. The communications module 1802 is configured to support the terminal in communicating with another network entity. The input/output module 1803 is configured to receive information input by the user or output information provided for the user and various menus of the terminal. The storage module 1804 is configured to store program code and data of the terminal.

For example, the processing module 1801 may be a processor or a controller, such as a central processing unit (CPU), a GPU, a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logical blocks, modules, and circuits described with reference to content disclosed in this application. The processor may be a combination implementing a computing function, for example, a combination of one or more microprocessors, or a combination of the DSP and a microprocessor.

The communications module 1802 may be a transceiver, a transceiver circuit, an input/output device, a communications interface, or the like. For example, the communications module 1802 may be a Bluetooth apparatus, a Wi-Fi apparatus, a peripheral interface, or the like.

The storage module 1804 may be a memory. The memory may include a high-speed random access memory (RAM), or may include a non-volatile memory, for example, a magnetic disk storage component, a flash memory, or another volatile solid-state storage component.

The input/output module 1803 may be an input/output device such as a touchscreen, a keyboard, a microphone, or a display. The display may be configured by using a liquid crystal display, an organic light emitting diode, or in another form. In addition, a touch panel may be further integrated into the display, and is configured to: collect a touch event on or near the touch panel, and send collected touch information to another component (for example, the processor).

All or some of the foregoing embodiments may be implemented by using software, hardware, firmware, or any combination thereof When a software program is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or another programmable apparatus. The computer instructions may be stored in a computer readable storage medium or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any available medium accessible by a computer, or a data storage device, such as a server or a data center, integrating one or more usable media. The available medium may be a magnetic medium (for example, a floppy disk, a hard disk, or a magnetic tape), an optical medium (for example, a DVD), a semiconductor medium (for example, a solid-state drive Solid State Disk (SSD)), or the like.

The foregoing descriptions are merely implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An application switching method implemented via a terminal, the application switching method comprising:
running, by the terminal, a first application in the foreground;
locking a screen of the terminal in response to a lock screen instruction; and
when the terminal meets a preset condition of running a second application and a priority of the second application is higher than a priority of the first application, unlocking the screen of the terminal in response to an unlock instruction, and running the second application in the foreground, wherein the first application is different from the second application.

2. The method according to claim 1, wherein the preset condition comprises: the terminal receiving a new message related to the second application while in a lock screen state, wherein
the new message comprises at least one of a short message service message, a missed call notification, an instant messaging message, an application update prompt, a push message, or an advertisement message.

3. The method according to claim 2, wherein running the second application in the foreground comprises:
running a detail interface of the new message in the second application in the foreground; or
running a preview interface of the new message in the second application in the foreground.

4. The method according to claim 2, wherein the new message is received by the terminal at a first moment; and
running the second application in the foreground comprises:
running a first interface of the second application in the foreground if the terminal receives the unlock instruction at a moment between the first moment and a second moment, wherein the second moment is later than the first moment; and
running a second interface of the second application in the foreground if the terminal receives the unlock instruction at a moment between the second moment and a third moment, wherein the third moment is later than the second moment.

5. The method according to claim 4, wherein if the terminal obtains the unlock instruction after the third moment, the method further comprises:
continuing to run the first application in the foreground.

6. The method according to claim 2, wherein
running the first application in the foreground comprises: running a first interface of the first application in the foreground; and
running the second application in the foreground comprises: when a priority of a target interface to which the new message belongs is higher than a priority of the first interface, running the target interface of the second application in the foreground.

7. The method according to claim 1, wherein the preset condition comprises: the terminal in a lock screen state detecting that the terminal is connected to an audio output device, and the second application is an application supporting audio playback.

8. The method according to claim 7, wherein running the second application in the foreground comprises:
running the second application in the foreground if the terminal receives the unlock instruction for the first time while in a state of being connected to the audio output device.

9. The method according to claim 1, wherein the preset condition comprises any of the following: the terminal in a lock screen state detecting that a current location is within a preset geo-fencing, or the terminal in a lock screen state detecting that a current time is within a preset time period.

10. The method according to claim 9, wherein the second application includes an attendance tracking application, the preset geo-fencing is near a preset clock-in/out location, and the preset time period is a preset clock-in/out time period.

11. The method according to claim 10, wherein running the second application in the foreground comprises:
running the second application in the foreground when the terminal receives the unlock instruction within the clock-in/out time period for the first time.

12. The method according to claim 9, wherein the second application includes a game or reading application, the preset geo-fencing is a historical location at which a user used the second application, and the preset time period is a historical time at which the user used the second application.

13. The method according to claim 9, wherein the second application includes an application comprising an e-ticket, and the preset geo-fencing is a station.

14-25. (canceled)

26. The method according to claim 1, further comprising:
when the terminal meets a preset condition of running a second application and a priority of the first application is higher than a priority of the second application, unlocking the screen of the terminal in response to an unlock instruction, and running the first application in the foreground.

27. A terminal, comprising:
a processor; and
a memory configured to store computer readable instructions that, when executed by the processor, cause the terminal to provide execution comprising:
running a first application in the foreground;
locking a screen of the terminal in response to a lock screen instruction; and
when the terminal meets a preset condition of running a second application and a priority of the second application is higher than a priority of the first application, unlocking the screen of the terminal in response to an unlock instruction, and running the second application in the foreground, wherein the first application is different from the second application.

28. The terminal according to claim 27, wherein the preset condition comprises: the terminal receiving a new message related to the second application while in a lock screen state, wherein
the new message comprises at least one of a short message service message, a missed call notification, an instant messaging message, an application update prompt, a push message, or an advertisement message.

29. The terminal according to claim 28, wherein the new message is received by the terminal at a first moment; and
running the second application in the foreground comprises:
running a first interface of the second application in the foreground if the terminal receives the unlock instruction at a moment between the first moment and a second moment, wherein the second moment is later than the first moment; and
running a second interface of the second application in the foreground if the terminal receives the unlock instruction at a moment between the second moment and a third moment, wherein
the third moment is later than the second moment, and
if the terminal obtains the unlock instruction after the third moment, the terminal continues to run the first application in the foreground in response to the unlock instruction.

30. The terminal according to claim 26, wherein the preset condition comprises any of the following:
the terminal in a lock screen state detecting that the terminal is connected to an audio output device, and the second application is an application supporting audio playback;
the terminal in a lock screen state detecting that a current location is within a preset geo-fencing, or
the terminal in a lock screen state detecting that a current time is within a preset time period.

31. The terminal according to claim 30, wherein the second application includes an attendance tracking application, the preset geo-fencing is near a preset clock-in/out location, and the preset time period is a preset clock-in/out time period.

32. The terminal according to claim 26, wherein the terminal is further caused to provide execution comprising:
when the terminal meets a preset condition of running a second application and a priority of the first application is higher than a priority of the second application, unlocking the screen of the terminal in response to an unlock instruction, and running the first application in the foreground.
